(19) United States
(12) Patent Application Publication
(10) Pub. No.: US 2019/0296933 A1
(43) Pub. Date: Sep. 26, 2019

(54) Controlling Devices Based on Sequence Prediction

(71) Applicant: Microsoft Technology Licensing, LLC, Redmond, WA (US)

(72) Inventors: Anirudh KOUL, San Jose, CA (US); Ranjitha GURUNATH KULKARNI, Sunnyvale, CA (US)

(21) Appl. No.: 15/927,043

(22) Filed: Mar. 20, 2018

(51) Int. Cl. H04L 12/28; G06F 13/10; G05B 15/02; G06F 9/445

(52) U.S. Cl. CPC H04L 12/2816; G06F 13/107; G05B 2219/2642; H04L 12/2829; G06F 9/44505; G05B 15/02

(57) ABSTRACT

A technique is described herein for facilitating the programming and control of a collection of devices. In one manner of operation, the technique involves: receiving signals from the collection of devices that describe a sequence of events that have occurred in operation of the collection of devices; storing the signals; determining a rule associated with the sequence of events using a machine-trained sequence-detection component (SDC), the rule identifying a next event in the sequence of events; determining whether the rule is viable; and, if the rule is determined to be viable, sending control information to at least one device in the collection of devices. The control information instructs the identified device(s) to perform the next event that has been identified.

### BACKGROUND

Households and other environments have increasingly adopted the use of smart devices. These devices include programmable electronic interfaces that allow them to interact with a more encompassing control environment via a computer network. For instance, the devices may report their operational states via their electronic interfaces. Further, the devices may receive control instructions through their electronic interfaces, which subsequently govern their operation.

But the enhanced interactivity of smart devices also introduces challenges. Users, for instance, may find it time-consuming and burdensome to manually program the smart devices, each of which may adopt a unique electronic interface. Tools exist to control smart devices in a conditional manner. For example, a user may create IF-THEN-type rules that govern the behavior of the smart devices in a manner that is dependent on the occurrence of specified events. But this technology still requires users to manually create the IF-THEN-type rules. Further, by increasing the complexity of smart devices, developers may also make it more difficult to understand and interact with their electronic interfaces.

### SUMMARY

A technique is described herein for facilitating the programming and control of a collection of devices. In one manner of operation, the technique involves: receiving signals produced by a collection of devices that describe a sequence of events that have occurred in the operation of the devices; storing the signals; determining a rule associated with the sequence of events using a machine-trained sequence-detection component (SDC), the rule identifying a next event in the sequence of events; determining whether the rule is viable; and, if the rule is determined to be viable, sending control information to at least one device in the collection of devices. The control information instructs the identified device(s) to perform the next event that has been identified.

In one non-limiting implementation, the SDC includes a Recurrent Neural Network (RNN) including a chain of RNN units. More specifically, in one implementation, each RNN unit corresponds to a Long Short-Term Memory (LSTM) unit.

According to another illustrative aspect, the technique determines whether a candidate rule is viable by determining whether it is present within a local rules data store, provided by a local control environment. If the rule is present (and also has been previously approved), the technique executes the rule, that is, by controlling one or more devices in a manner specified by the rule. If the rule is not present in the local rules data store, the technique sends a message to the user which asks the user to accept or reject the rule.

According to another illustrative aspect, the technique leverages insight provided by a local control system and a global control system. For instance, upon adding a new device to the local control environment, a local control system receives a set of default rules associated with the new device from a global control system. The global control system, in turn, generates the default rules based on feedback received from plural local control systems. In some cases, a set of default rules may generally pertain to a family of devices to which the new device belongs, instead of being narrowly tailored to the particular new device that has been added.

According to another illustrative aspect, a training framework continuously (or periodically) updates a model used by the SDC based on the signals provided by the collection of devices.

According to one benefit, the technique greatly facilitates the task of creating rules for use in controlling devices. For instance, the technique, creates rules in an automated or semi-automated manner, eliminating or reducing the need for users to program the devices in a manual and ad hoc manner.

The above-summarized technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative computing environment for controlling a collection of devices. The computing environment includes a local control system and a global control system.

FIG. 2 shows one computing system for implementing the computing environment of FIG. 1.

FIG. 3 shows a local prediction component and a local decision component, which correspond to two components of the local control system of FIG. 1.

FIG. 4 shows a mapping table. An input mapping component (of the local prediction component of FIG. 3) may use such a mapping table for generating input vectors, which are then fed to respective units of a Recurrent Neural Network (RNN).

FIG. 5 shows one implementation of an RNN that uses Long Short-Term Memory (LSTM) units, for use in the local prediction component of FIG. 3.

FIG. 6 shows one implementation of a local training framework, which is another component of the local control system of FIG. 1.

FIG. 7 shows one implementation of the global control system of FIG. 1.

FIGS. 8 and 9 describe two kinds of global analysis components for use in the global control system of FIG. 7.

FIG. 10 shows a process that explains one way in which the local control system of FIG. 1 handles the introduction of a new device to a collection of devices.

FIG. 11 shows a process that provides an overview of one manner of operation of the local control system of FIG. 1.

FIG. 12 shows a process that describes one way of validating a candidate rule in the context of the process of FIG. 11.

FIG. 13 shows a process that explains one way of training a model for use in the local control system of FIG. 1.

FIG. 14 shows an illustrative type of computing device that can be used to implement any aspect of the features shown in the foregoing drawings.

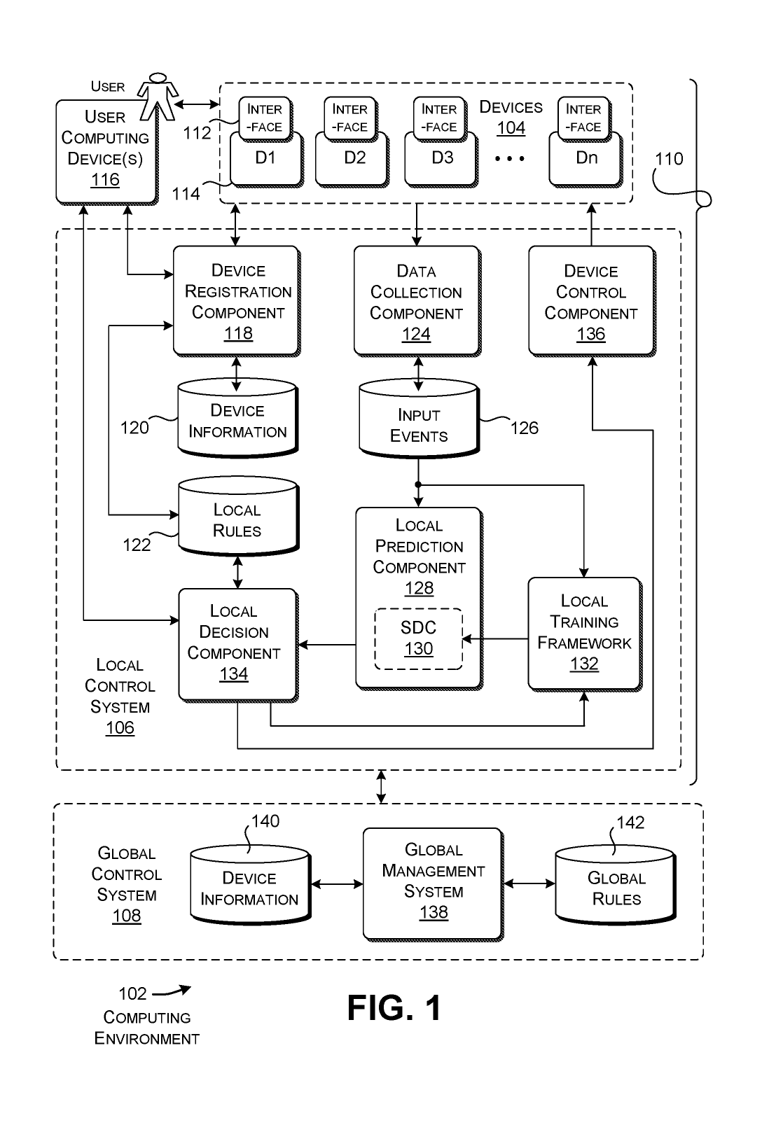

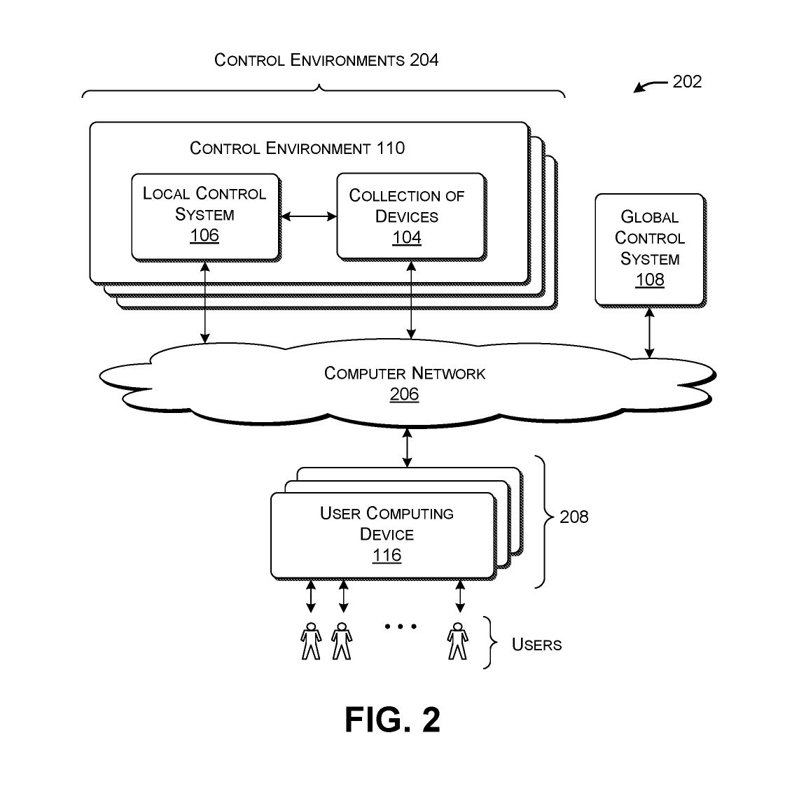

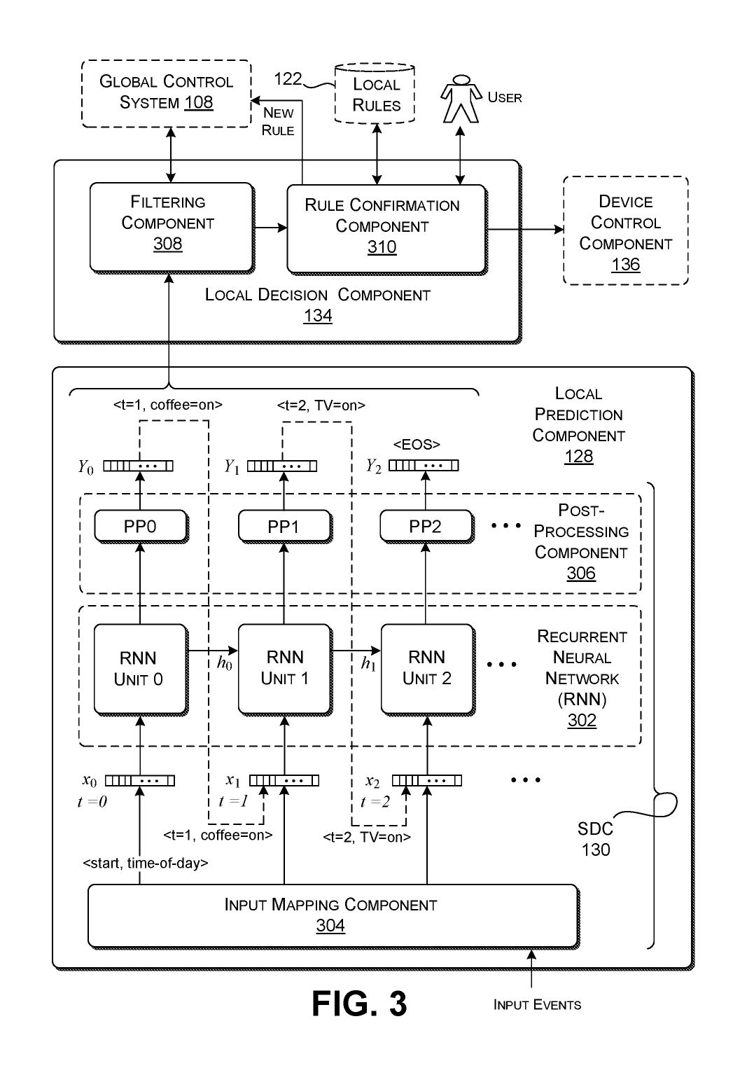

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computing environment for generating rules used to control a collection of devices, and then using those rules to control the devices. Section B sets forth illustrative methods which explain the operation of the computing environment of Section A. And Section C describes illustrative computing functionality that can be used to implement any aspect of the features described in Sections A and B.

As a preliminary matter, the term “hardware logic circuitry” corresponds to one or more hardware processors (e.g., CPUs, GPUs, etc.) that execute machine-readable instructions stored in a memory, and/or one or more other hardware logic components (e.g., FPGAs) that perform operations using a task-specific collection of fixed and/or programmable logic gates. Section C provides additional information regarding one implementation of the hardware logic circuitry.

The terms “component,” “unit,” “element,” etc. refer to a part of the hardware logic circuitry that performs a particular function. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts that pertain to processing-related functions can be implemented by the hardware logic circuitry described in Section C, which, in turn, can be implemented by one or more hardware processors and/or other logic components that include a task-specific collection of logic gates.

As to terminology, the phrase “configured to” encompasses various physical and tangible mechanisms for performing an identified operation. The mechanisms can be configured to perform an operation using the hardware logic circuity of Section C. The term “logic” likewise encompasses various physical and tangible mechanisms for performing a task. For instance, each processing-related operation illustrated in the flowcharts corresponds to a logic component for performing that operation. A logic component can perform its operation using the hardware logic circuitry of Section C. When implemented by computing equipment, a logic component represents an electrical component that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative Computing Environment

A.1. Overview

FIG. 1 shows an illustrative computing environment 102 for controlling a collection of devices 104. The computing environment 102 includes a local control system 106 and a global control system 108. The devices 104 and the local control system 106 correspond to a local control environment 110. For instance, without limitation, the local control environment 110 may correspond to a household, a business environment, a governmental environment, and educational environment, a vehicle-related environment, etc. The local control environment 110 may also have any scope. For instance, the local control environment 110 may correspond to a single housing unit, a building that includes plural housing units, or a campus composed of plural buildings, etc. Although FIG. 1 only shows a single local control environment 110, the global control system 108 may interact with plural such local control environments. For instance, the global control system 108 may interact with plural local control environments associated with respective households, each of which includes its own collection of devices.

The devices 104 can include any assortment of mechanism that perform any function. More generally, in current parlance, the devices 104 can include, but are not limited to, Internet-of-Things (IoT) devices (also known as smart devices). In a typical household setting, the devices 104 can include, without limitation: heater mechanisms, lighting mechanisms, window fixture control mechanisms, kitchen appliances, door-locking mechanisms, entertainment devices, clothes washers, clothes dryers, and so on. In non-domestic settings, the devices can perform any environment-specific functions. For instance, in a manufacturing setting, the devices can correspond to different machines in an assembly line of machines.

Each device includes a manufacturer-specific programmable electronic interface. FIG. 1 shows one representative electronic interface 112 associated with one representative device 114. The electronic interface 112 provides a mechanism that exposes the device's operational states to the local control system 106. For example, the electronic interface of an oven may identify whether it is on or off, its current temperature, its current timer setting, etc. The electronic interface 112 also provides a mechanism for receiving a control instructions from the local control system 106. For instance, in the case of an oven, the electronic interface may receive instructions to turn the oven on or off at a particular time of the day, etc.

Users may interact with the local control system 106 via one or more user computing devices 116, referred to in the singular below for simplicity. The user computing device 116 may correspond to any computing apparatus, such as a desktop computing device, a laptop computing device, a tablet-type computing device, a smartphone or other handheld computing device, a game console device, a wearable computing device, a mixed-reality device, a specialized voice interaction device, and so on.

In some implementations, the user may interact with the local control system 106 (e.g., via the local user computing device 116) using a digital assistant mechanism, such as the CORTANA system provided by MICROSOFT CORPORATION of Redmond, Wash. For instance, the local control system 106 can leverage the digital assistant mechanism to solicit input information from the user (as described below). In addition, the local control system 106 can use the digital assistant mechanism to notify the user of certain events (as described below).

The local control system 106 includes a device registration component 118 for handling the registration of a new device that is added to the collection of devices 104. A new device corresponds to a device that differs in kind from the devices in the collection of devices 104. For example, assume that the collection of devices 104 does not include (and never included) a coffee machine. A coffee machine would therefore constitute a new device as defined herein. The device registration component 118 can determine that a user has added a new device by comparing a device ID and/or category ID(s) associated with the new device with the IDs associated with the existing devices 104.

The device registration component 118 can perform at least two registration-related functions. According to one function, the device registration component 118 collects device interface information regarding the characteristics of the new device's electronic interface. That is, the device interface information identifies the operational states that the new device may assume, together with the control instructions that it may accept to modify its operational states. In operation, the device registration component 118 sends a message to a source of device interface information, specifying a device ID associated with the new device and/or a category ID (or category IDs) associated with the new device. In response, the source supplies the requested device interface information to the device registration component 118. In one case, the device registration component 118 can collect the device interface information from an online repository of information published by the manufacturer of the new device. In another case, the device registration component 118 can retrieve the device interface information from the global control system 108; the global control system 108, in turn, may store device interface information in response to receiving this information from one or more other households in which the same new device (or a related device) has already been installed. In still other cases, the device registration component 118 can collect the device interface information from the new device itself, provided that it is designed to directly furnish this information. The device registration component 118 stores the device information that is received in a device information data store 120.

Alternatively, assume that the device registration component 118 cannot obtain the device interface information from any of the above-identified sources. In that case, the device registration component 118 may ask the user to manually input this information via the user computing device 116.

As a second function, the device registration component 118 receives a collection of default rules from the global control system 108, and stores these rules in a local rules data sore 122. That is, in one implementation, the device registration component 118 sends a device ID and category ID(s) associated with the new device to the global control system 108. In response, the global control system 108 returns a collection of default rules that may be employed to govern the operation of the new device. In some cases, the default rules are specifically tailored to the new device, e.g., because they specifically pertain to a device having the same manufacturer and the same model number as the new device. Alternatively, or in addition, the default rules pertain to a common family of devices to which the new device belongs. For example, assume that the new device is a new refrigerator. The default rules may pertain to any refrigerator produced by any manufacturer, so long as it performs the same core functions as the new refrigerator.

In one manner of operation, the global control system 108 can first attempt to find a set of default rules that matches the device ID associated with the new device. If this fails, then the global control system 108 can attempt to retrieve a set of default rules that match the category ID(s) associated with the new device.

In another implementation, the global control system 108 can retrieve default rules using a hierarchical index of devices. The hierarchical index identifies different categories of devices, ranging from broad categories (corresponding to root nodes at the top of the hierarchy) to narrow categories (corresponding to child nodes at the bottom of the hierarchy). In one manner of operation, the global control system 108 retrieves default rules using the index by first attempting to extract those default rules that are most specific to the new device. As appropriate, the global control system 108 may then “move up” the index to identify default rules associated with the new device's family, etc.

As will be described below, the global control system 108 creates a set of default rules in response to rules forwarded to the global control system 108 by plural local control systems. In many cases, a local control system which supplies a default rule automatically discovers it in the course of interacting with its own collection of devices. Additional details regarding the operation of the global control system 108 are set forth below in Subsection A.5 in connection with the description of FIGS. 7-9.

More generally, the local control system 106 leverages a set of default rules to bootstrap the local control system 106 with respect to the installation of the new device. This avoids (or reduces) the need for a user to manually create new rules for the new device. The local control system 106 may subsequently revise any aspect of the default rules, such as by rejecting or modifying one or more of the default rules, adding new rules, etc. In addition, the device registration component 118 may offer the user a chance to modify any of the default rules upon their initial introduction to the local control system 106.

A data collection component 124 receives signals from the devices 104 that describe a sequence of events in the operation of the devices 104. For example, the signals may contain information that identifies the following sequence of events: (1) a doors is unlocked; (2) the door is opened; (3) a first illumination source (light₁) near the door is turned on; (4) a second illumination source (light₂) is turned on; (5) the first illumination source (light₁) is turned off; (6) a television set is turned on, etc. More specifically, each signal can describe at least: the time at which the event occurred; the ID of the device associated with the event; and a state associated with the event (e.g., the fact that a device was turned on), etc. The data collection component 124 stores the signals in an events data store 126.

The data collection component 124 can use any strategy(ies) to collect the signals. For instance, the data collection component 124 can use a pull strategy by periodically polling the devices 104 to determine whether any of their operational states have changed. A device that has undergone a change in operational state will respond by sending a signal to the data collection component 124. Alternatively, or in addition, the data collection component 124 can use a push strategy, in which each device proactively sends a signal to the data collection component 124 when its operational state has changed.

A local prediction component 128 examines a stream of events captured by the data collection component 124 to determine, at each given time t_{current}, whether a portion of the stream matches a predetermined pattern. Each such pattern identifies a previously-encountered sequence of events E₁, E₂, E₃, . . . , Eₙ, only an initial subset of which may be observed at the current time. For example, assume that at the current time, the data collection component 124 has received the first three events described above, corresponding to: E₁=door is unlocked; E₂=door is opened; and E₃=light₁ is turn on. The local prediction component 128 can determine that this sequence matches a previously-encountered pattern. That pattern, in its entirely, includes three follow-on events: E₄=light₂ is turned on; E₅=light₁ turns off; and E₆=television set is turned on.

The local prediction component 128 uses a machine-trained sequence-detection component (SDC) 130 to determine whether an input event sequence matches a previously-encountered sequence. For instance, the SDC 130 can use a Recurrent Neural Network (RNN) to perform this assessment. In other cases, the SDC 130 can use a language model (e.g., an n-gram model), a Hidden Markov Model (HMI), a Gaussian Mixture Model (GMM), a Conditional Random Fields (CRFs) model, etc. Additional representative details regarding the SDC 130 are set forth below in Subsection A.2 in connection with the explanation of FIGS. 3-5.

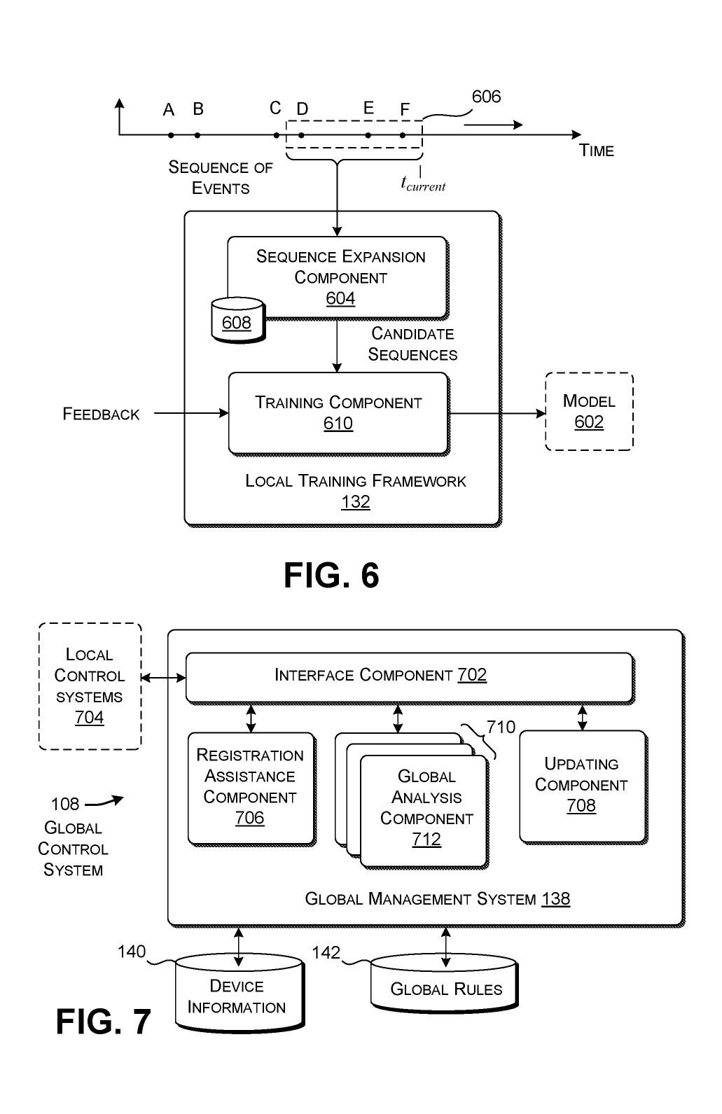

The SDC 130 uses a machine-trained model to govern its operation, which includes a set of parameter values. A local training framework 132 continuously (or periodically) updates the model based on the sequence of events captured by the data collection component 124. Additional representative details regarding the local training framework 132 are set forth below in Subsection A.4 in connection with the explanation of FIG. 6.

A local decision component 134 determines whether the candidate rule generated by the local prediction component 128 is viable. The local decision component 134 may make this determination based on plural factors. As one factor, the local decision component 134 can determine whether a score associated with the candidate rule satisfies a prescribed relevance rule, such as a prescribed threshold. As a second factor, the local decision component 134 optionally determines whether the global control system 108 has flagged the candidate rule as unviable, which, in turn, is based on insight gathered from plural other local control environments.

Presume that the candidate rule passes the two above-identified tests. As a third factor, the local decision component 134 determines whether the candidate rule is already present in the local rules data store 122, and whether it is marked as approved. If this is true, then the local decision component 134 forwards the rule to a device control component 136 for execution. If the rule is not present in the rules data store, then the local decision component 134 sends a message to the user via the user computing device 116, e.g., via text message, Email, digital assistant-delivered message, etc. The message invites the user to approve or decline the candidate rule. Upon receiving the user's response, the local decision component 134 updates the local rules data store 122 to indicate that the candidate rule is now approved (or rejected). If approved, then the local decision component 134 forwards the rule to the device control component 136 for execution. The local decision component 134 can also provide the user's response to the local training framework 132. The local training framework 132 uses this feedback when it next updates the SDC 130. Additional representative details regarding the local decision component 134 are provided below in Subsection A.3 in connection with the explanation of FIG. 3.

The device control component 136 sends control instructions to the devices 104 based on invoked rules. For example, again consider the example in which the event E₁ corresponds to a door being unlocked, event E₂ corresponds the door being opened, and event E₃ corresponds to a light₁ turning on. The device control component 136 may send an instruction that carries out at least the next event (E₄) in the detected pattern, e.g., by sending a control instruction to light₂, requesting it to turn on. More generally, each control instruction identifies the address of the device to which it is directed, an action that the device is requested to take, and (optionally) a time at which the device is requested to take the action. In some implementations, a control instruction may alternatively request a device to cancel or modify a previously received control instruction.

In some implementations, the device control component 136 sends a control instruction to a device a short time prior to the time it is requested to take action. For example, assume that a predetermined pattern indicates that the user typically turns on light₂ three minutes after turning on light₁. In this case, the device control component 136 may send a control instruction to light₂ 15 seconds (for example) prior to its scheduled time of activation. This strategy of activation is beneficial because the local prediction component 128, prior to a scheduled time of activation, can receive events that increase or decrease the confidence of a previously detected pattern. This strategy gives the local control system 106 the opportunity to cancel or modify a previous rule that has been sent to the device control component 136 for execution, prior to the device control component 136 actually disseminating control instructions to the affected device(s).

In other scenarios, the device control component 136 can send instructions to any number of devices based on plural next events in a detected pattern. For example, in another implementation, the device control component 136 can simultaneously send control instructions associated with events E₄, E₅, and E₆ identified above upon detecting a telltale pattern based on received events E₁, E₂, and E₃, that is, by sending control instructions to light₂, light₁, and the television set, respectively.

Now referring to the global control system 108, a global management system 138 manages all functions performed by the global control system 108. One such function corresponds to maintaining a global device information data store 140 that provides device interface information regarding known devices. The global management system 138 may receive this information from online sites provided by device manufacturers. In addition, or alternatively, the global management system 138 may receive device interface information from the local control environments.

The global management system 138 also includes a registration assistance component (not shown in FIG. 1) for providing default rules to the device registration component 118 upon request. In performing this task, it retrieves an appropriate set of default rules from a global rules data store 142. The global management system 138 also includes one or more global analysis components (not shown in FIG. 1) for verifying the viability of candidate rules identified by the local control system 106, and performing other functions. Additional details regarding the operation of the global management system 138 are set forth below in Subsection A.5 in connection with the explanation of FIGS. 7-9.

In summary, the computing environment 102 of FIG. 1 has a various characteristics that enable it to efficiently control the collection of devices 104. For instance, the local control system 106 can automatically (or semi-automatically) generate rules for the devices 104, greatly reducing the amount of manual programming required by the user. The local control system 106 accomplishes this task by automatically detecting salient patterns in the event sequences that occur within the local control environment 110.

Further, the computing environment 102 provides an efficient technique for introducing a new device to the local control environment 110. It performs this task by leveraging a set of default rules provided by the global control system 108. This provision reduces the amount of manual work a user is expected to perform when introducing a new device to the local control environment 110.

Further, the computing environment 102 provides a way of generating rules for families of devices, in addition to individual device models. This provision is useful because it expands the utility and flexibility of the computing environment 102. For instance, the computing environment 102 can successfully provide a collection of default rules for a device's family when default rules associated with the specific device model under consideration cannot be found.

FIG. 2 shows one computing system 202 for implementing the computing environment 102 of FIG. 1. The computing system 202 incudes plural local control environments 204, including the representative control environment 110 illustrated in FIG. 1 and described above. The local control environment 110 includes the local control system 106 together with a collection of devices 104. The local control system 106 may correspond to one or more servers provided at a single site or distributed over plural sites. The collection of devices 104 may correspond to any assortment of the kinds of devices described above.

Each local control system interacts with the global control system 108 via a computer network 206. The global control system 108 may correspond to one or more servers, provided at a single site or distributed over plural sites. The computer network 206 can correspond to a local area network, a wide area network (e.g., the Internet), one or more point-to-point links, etc., or any combination thereof. The computer network 206 may be governed by any protocol or combination of protocols.

The computing system 202 can include a collection of user computing devices 208, including the representative user computing device 116 described above. Each user computing device can correspond to any type of computing apparatus described above. FIG. 2 illustrates the user computing devices 208 as separate from the local control environments 204. But some of the user computing devices 208 can be considered as part of respective local control systems insofar as they operate within respective local control environments. For example, the user computing device 116 can be considered as part of the local control environment 110.

A.2. The Local Prediction Component

FIG. 3 shows the local prediction component 128 introduced in connection with FIG. 1. The local prediction component 128 receives a sequence of input events from the events data store 126. (In the following description, “event” is used as a shorthand reference to digital information which represents an event.) It then determines whether the sequence of events matches any predetermined event pattern. If so, it forwards a candidate rule to the local decision component 134 that is associated with the detected pattern. The local prediction component 128 performs this task with reference to the sequence-detection component (SDC) 130. In the non-limiting case of FIG. 3, the logic of the local prediction component 128 is coextensive with the logic associated with the SDC 130; hence, the following explanation will refer to the local prediction component 128 as the SDC 130 itself. The SDC 130 performs its operation using a model provided by the local training framework 132. The model corresponds to a set of parameter values which control the operation of the logic provided by the SDC 130.

In the non-limiting case of FIG. 3, the SDC 130 includes a Recurrent Neural Network (RNN) 302. The RNN 302, in turn, includes a collection of RNN units (RNN Unit 0, RNN Unit 1, RNN unit 2, etc.). More specifically, the SDC 130 dynamically expands and contracts its number of RNN units to accommodate the number of events in a sequence it seeks to analyze.

Each RNN unit receives an input vector xᵢ that describes an event. It uses its internal neural network logic to map the input vector xᵢ to an RNN output vector yᵢ. For instance, as will be set forth below, each RNN unit may correspond to a Long Short-Term Memory (LSTM) unit. Each RNN unit also receive an input hidden state vector hᵢ₋₁ from a preceding RNN unit (if any), and provides an output hidden state vector hᵢ to a next RNN unit (if any) in the sequence of RNN units. In some implementations, the RNN 302 corresponds to unidirectional RNN which passes hidden state information in one direction along the chain of RNN units. In another implementation, the RNN 302 corresponds to a bidirectional RNN which passes hidden state information in both directions, that is, from left to right in the figure, and from right to left.

An input mapping component 304 maps each event that it receives into an index value. The input mapping component 304 then converts the index value into a one-hot input vector xᵢ. A one-hot vector corresponds to vector having a “1” entry in a designated dimension (associated with a particular index value), and “0” entries in other dimensions. The input mapping component 304 then supplies each input vector xᵢ to an appropriate RNN unit i. A post-processing component 306 maps each RNN output vector yᵢ into a SDC output vector (or scalar) Yᵢ. For example, the post-processing component 306 may correspond to a normalized exponential function, also knows as a softmax function.

Consider the following example to illustrate the operation of the SDC 130. Assume that the input mapping component 304 receives a first event in an event sequence which describes an observation that a coffee machine has turned on. That event, as received, includes information that identifies the time at which the coffee machine has turned on, an ID associated with the coffee machine, and a description of the action performed by the coffee machine (here, indicating that the coffee machine has turned on). In response to this event, the input mapping component 304 can create a start-of-sequence input vector x₀. That vector communicates that a start of a sequence has occurred. It feeds the input vector x₀ to the RNN unit 0. It also creates a first input vector x₁ that describes the first event in the sequence (here, the fact that the coffee machine has turned on). It feeds that input vector x₁ to the RNN unit 1.

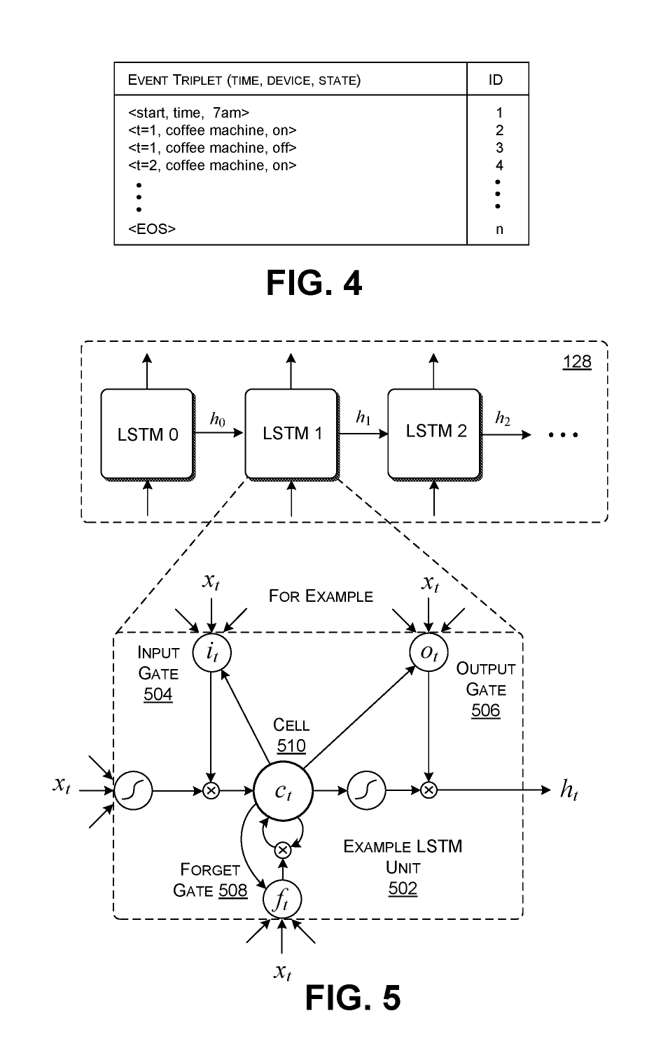

More specifically, in one non-limiting implementation, the input mapping component 304 maps a first tuple <start token, time, 7:00 am> to a first index value, e.g., value 1 (for example). Here, the time (7:00 am) correspond to an actual time of the day at which the coffee machine has turned on. The input mapping component 304 maps a second tuple <t=1, ID=coffee, state=on> to a second index value, e.g., value 2 (for example). Here, the input time (t=1) maps to a relative time, indicating the position of the event in a sequence of events. In one implementation, the input mapping component 304 can use a lookup table or a hashing function to map each input event into an index value, such as the representative and non-limiting mapping table shown in FIG. 4. The input mapping component 304 then converts each index value into a one-hot vector and feeds it to the appropriate RNN, e.g., by sending x₀ to RNN unit 0, and x₁ to RNN unit 1. This input mapping behavior is described in the spirit of illustration, not limitation; other implementations can use other strategies for mapping events to input vectors, such as by using a separate feed-forward neural network to map information regarding an event to an input vector.

In response to the above-described input, assume that the RNN unit 0 produces a hidden state vector h₀ and an RNN output vector y₀ (which is ignored). The RNN unit 1 maps the input vector x₁ and the hidden state vector h₀ to an RNN output vector y₁, which, in turn, maps to a SDC output vector Y₁. Finally, assume that the SDC output vector Y₁ corresponds to a predicted event indicating that a television set is turned on (which, in turn, can be determined by using a lookup table or the like to map the vector Y₁ to an actual event). In other words, at this stage, the RNN unit 1 provides a prediction that the television set will turn on following the turning on of the coffee machine. (Note that the actual turning on of the television set has not yet been observed.)

The SDC 130 next feeds the SDC output vector Y₁ as an input to the RNN unit 2. In other words, the SDC treats the SDC output vector Y₁ as the input vector x₂. Assume that the RNN unit 2 next maps the input vector x₂ (and a hidden state vector h₁ supplied by the RNN unit 1) to an RNN output vector y₂, which, in turn, maps to an SDC output vector Y₂. Finally, assume that the SDC output vector Y₂ corresponds to an end-of-sequence (EOS) token which indicates that the RNN unit 2 predicts that the event identified by the RNN unit 1 (corresponding to the television set turning on) is the last action in the detected pattern.

The detected pattern, in turn, corresponds to a detected rule. Here, the rule posits that the television set should be turned on following the coffee machine turning on. In some cases, a detected rule will be dependent on the time encoded in the input vector x₀. In other cases, a detected rule will have no time-dependency, or only weak time dependency. For instance, a user's morning routine may involve fixing coffee and then sitting down to watch television. Here, a particular time of day (e.g., 7:00 am) likely has a strong correlation to the turning on of the coffee machine and the subsequent turning on of the television. But assume that another user drinks coffee all day long, and, on each occasion, turns on the television set. Here, these two paired events have less of a nexus to any particular time of day. The local training framework 132 automatically derives the above conclusions by analyzing many sequences of events that have been observed by the local control system 106 over a span of time.

Now consider another scenario that varies somewhat from the above-described case. Assume that the RNN unit 2 does not detect that an end-of-sequence has occurred. Rather, assume that the RNN unit 2 predicts another non-terminal event in the sequence of events, such as a light turning off behind the television. And further assume that no subsequent RNN (RNN unit 3, RNN unit 4, etc.) detects an end-of-sequence token with sufficient confidence. In response to this situation, the SDC 130 takes no control action at this time. Rather, it waits until it receives another actual event in the sequence of events. For example, assume that the SDC 130 next receives an event that indicates that the television set has turned on as predicted. It will then feed the same input vectors (x₀, x₁) described above to the RNN unit 0 and the RNN unit 1, respectively (effectively ignoring the SDC output vectors Y₀ and Y₁). The SDC 130 will then produce a new input vector x₂ that describes the television set turning on, which it feeds to the RNN unit 2. The resultant SDC output vector Y₂ describes the RNN unit 2's prediction as to what event is likely to follow the turning on of the television set. Assume that this predicted event corresponds to a light turning on behind the television. The SDC 130 next maps the SDC output vector Y₂ to an input vector (x₃), which it then feeds to an RNN unit 3 (not shown). If the RNN unit 3 predicts that an end-of-sequence token has now occurred, then the SDC 130 forwards the resultant detected rule to the local decision component 134. If no end-of-sequence token is detected by the RNN unit 3 (or any subsequent RNN unit), then the SDC 130 repeats the above operation by receiving and analyzing another event in the sequence of events of increasing length. To accommodate this operation, the SDC 130 dynamically expands on as as-needed basis.

FIG. 5 shows one implementation of an RNN that uses a chain of Long Short-Term Memory (LSTM) units. Without limitation, FIG. 5 also shows the architecture of one of the LSTM units, namely LSTM unit 1 (labeled as unit 502 in FIG. 5). The LSTM unit 502 includes an input gate 504, an output gate 506, a forget gate 508, and a cell 510. The LSTM unit 502 processes signals in a manner specified by the following equations:

iₜ=σ(Wₓᵢxₜ+Wₕᵢhₜ₋₁+W_{ci}cₜ₋₁+bᵢ) (1)

fₜ=σ(W_{xf}xₜ+W_{hf}hₜ₋₁+W_{cf}cₜ₋₁+b_{f}) (2)

cₜ=fₜcₜ₋₁+iₜ tanh(W_{xc}xₜ+W_{hc}hₜ₋₁+b_{c}) (3)

o_{f}=σ(Wₓₒxₜ+Wₕₒhₜ₋₁+W_{co}cₜ+bₒ) (4)

hₜ=oₜ tanh(cₜ) (5).

In this set of equations, t refers to current processing instance, x refers to an input vector that represents a token of the input sequence, and i, o, f, and c represent vectors associated with the input gate 504, the output gate 506, the forget gate 508, and the cell 510, respectively. h represents a hidden state vector associated with the hidden state. σ represents a logistic sigmoid function. The various weighting terms (W) and bias terms (b) symbols represent sets of machine-learned parameter values, with subscripts associated with the above-defined symbols.

The use of LSTM units is merely illustrative. In another example, for instance, the RNN 302 can use Gated Recurrent Units (GRUs).

A.3. The Local Decision Component

Returning to FIG. 3, this figure also shows one implementation of the local decision component 134. Overall, the local decision component 134 determines whether a candidate rule generated by the local prediction component 128 is viable. It does so by applying one or more tests on the candidate rule.

For instance, a filtering component 308 may first determine whether a confidence score associated with the candidate rule satisfies a prescribed relevance rule. For example, each RNN unit can generate a confidence value which indicates the likelihood that its prediction is correct. The filtering component 308 can compare one or more of these confidence values to a threshold value. The filtering component 308 will reject the rule if these confidence value(s) fail to satisfy the threshold. If a rule is rejected, the SDC 130 will continue by receiving a new event and repeating its processing with respect to an updated sequence (which now includes one more event to analyze).

In addition, the filtering component 308 can consult the global control system 108 to determine whether the candidate rule is valid. In response, the global control system 108 can compare the rule with a list of known high-confidence rules and/or a list of known low-confidence rules. A high-confidence rule is a rule that has been assigned high confidence as being correct. A low-confidence rule is a rule that has been assigned low confidence as being correct. The global control system 108, in turn, can generate such lists of rules based on insight gathered by the feedback provided by plural control environments. For example, assume that the global control system is asked to verify the viability of a rule which specifies that an exterior light should be turned on at 2:00 pm in the afternoon. Feedback from multiple control environments may indicate that outdoors lights are rarely turned on during the daytime. Hence, the global control system 108 can assign a low score to the proposed rule, even if the local SDC 130 assigns a high score to this candidate rule. Alternatively, or in addition, the global control system 108 uses a separate machine-trained model to assess the viability of a candidate rule proposed by the local control system 106.

In some cases, the filtering component 308 can accept the conclusion generated by the global control system 108 without consideration of the confidence that it locally assigns to the rule. In other cases, the filtering component 308 can consider a combination of a local score and global score in deciding whether a proposed rule is viable. For example, the filtering component 308 can generate a weighted sum of the local score and the global score, and then compare that weighted sum with a threshold value.

Assume that the filtering component 308 indicates that a candidate rule satisfies its tests. If so, a rule confirmation component 310 determines whether the proposed rule is present in the local rules data store 122, and, if present, whether the rule has been previously approved. Note that the local rules data store 122 provides a combination of default rules received upon registration of each new device, together with rules that have been approved (or rejected) by local users on prior occasions.

There are three scenarios that the rules confirmation component 310 may encounter when considering a candidate rule. In a first scenario, assume that the local rules data store 122 indicates that a proposed candidate rule is present and has been previously approved. (A default rule may be considered approved by default.) If this case applies, the rule confirmation component 310 instructs the device control component 136 to carry out the rule.

In a second scenario, assume that the local data store 122 indicates that a proposed candidate rule is present but has been rejected on a prior occasion. In that case, the local decision component 134 may abandon the candidate rule and instruct the local prediction component 128 to continue analyzing new events in the sequence of events. This behavior is configurable. For instance, in another implementation, the rule confirmation component 310 can periodically ask the user to reconfirm that the candidate rule remains rejected.

In a third scenario, assume that the local rules data store 122 does not contain any record of the proposed rule. In this case, the rule confirmation component 310 sends a message to a local user, asking that user to either accept or decline the new rule. The message describes the proposed rule in any detail, such as by describing the events which have triggered the rule, together with the action(s) that will be invoked by the rule. In the example shown in FIG. 3, the candidate rule performs the action of turning on the television set. If the local user approves the candidate rule, the rule confirmation component 310 instructs the device control component 136 to carry out the rule. The local decision component 134 also updates the local rules data store 122 to indicate that a new rule has been approved, e.g., by storing the new rule together with metadata that indicates that the user has approved it. It may also notify the global control system 108 of the approval of a new rule.

On the other hand, if the user declines the new rule, the local decision component 134 instructs the local prediction component 128 to continue processing events until a new rule is detected. The local decision component 134 can also store an indication that the user has rejected the candidate rule in the local rules data store 122, e.g., by storing the rule together with metadata that indicates that the user has rejected it. It may also notify the global control system 108 of the rejection of the new rule. The local decision component 134 may leverage an indication that the user has rejected a proposed rule by refraining from asking the user to consider its validity if it is encountered again. As stated above, this behavior if configurable and may be changed.

Some new rules that are encountered are close counterparts of already accepted or rejected new rules. Hence, the rule confirmation component 310 can assess the similarity of a rule to already accepted and rejected rules prior to asking the user to accept or decline the current candidate rule under consideration. The rule confirmation component 310 can use any rules-based or machine-trained model to assess the similarity between a current rule and any prior accepted or rejected rule. For example, the rule confirmation component 310 can map two rules into respective vectors in a semantic space (e.g., using a deep neural network), and then use cosine similarity (or some other distance metric) to determine the similarity between the two vectors. A distance smaller than a prescribed threshold indicates that the rules are deemed similar.

The rule confirmation component 310 may also provide an interface that allows a user to manually modify any proposed rule. The rule confirmation component 310 thereafter marks the modified rule as approved by the user.

Finally, the local decision component 134 may also forward information regarding the user's approval and rejection of new rules to the training framework 132. As set forth below, the local training framework 132 may use this feedback information to assist in updating the model that governs the behavior of the SDC 130.

A.4. The Local Training Framework

FIG. 6 shows one implementation of the local training framework 132 introduced in Subsection A.1 with reference to FIG. 1. The local training framework 132 generates a model 602 that governs the operation of the SDC 130. For instance, with respect to the RNN 302 implementation of FIG. 3, the local training framework 132 generates a collection of parameter values that govern the operation of each RNN unit, such as each LSTM unit. For instance, the parameter values may specify weighting values and bias values, etc.

In one implementation, the local training framework 132 can receive a default model from the global control system 108 when the local prediction component 128 is first installed in the local control environment 110. The global control system 108, in turn, can generate the default model based on training data received from plural sources, such as other local control environments.

Thereafter, the local training framework 132 adjusts the default model on a continual or periodic or on-demand basis based on new events identified by the data collection component 124. Assume, for example, that in the last twenty minutes, the data collection component 124 has identified six new events, generically labeled in FIG. 6 as events A, B, C, D, E, and F.

In one implementation, the local training framework 132 includes a sequence expansion component 604 that identifies a subset of the most recent events that occur in a moving window 606 of time. The window 606 of time extends from a time t (t_{current}−n) to a time t_{current}, where n correspond to some increment of time (such as five minutes, 10 minutes, etc.). In the example of FIG. 6, the window 606 encompasses events D, E, and F, together with an initial start token <T> that defines the time at which the initial event candidate sequence has occurred. The sequence expansion component 604 then enumerates various in-order candidate sequences based on the events within the window 606, that is, <T>D, <T>E, <T>F, <T>DE, DE, <T>EF, EF, <T>DEF, and DEF. In other words, the sequence expansion component 604 identifies all in-order n-grams that can be composed from the set of events demarcated by the window 606. Note that the collection of candidate sequences includes examples in which a sequence is dependent on time, as well as examples in which a sequence is not dependent on time. The sequence expansion component 604 stores all candidate sequences that it generates in a sequence candidate data store 608.

The sequence expansion component 604 advances the window 606 on a periodic basis, such as at the end of each passing minute. Upon determining that the window 606 encompasses a different subset of events (such as by including a new event G), the sequence expansion component 604 forms a new set of candidate sequences in the manner specified above.

A training component 610 updates the model 602 based on sequence candidates in the data store 608, together with feedback provided by the local users' acceptance and rejection of proposed rules. The training component 610 can perform this task on any basis, such as continuously or periodically or on an on-demand basis. In operation, the training component 610 may tag each candidate sequence as an invalid pattern if the user has explicitly rejected it. Otherwise, the training component 610 tags the candidate sequence as a valid pattern. In addition, the training component 610 may assign a high confidence to those candidate sequences that a user has explicitly accepted as correct. With this labeled training set, the training component 610 then updates its parameter values of the model 602 to satisfy a training objective, such as by maximizing its ability to predict correct patterns and minimizing its tendency to produce incorrect patterns (which the user has rejected). The training component 610 can use any iterative training paradigm to achieve this result, such as, without limitation, a stochastic gradient descent technique. The training component 610 may compute the gradient using a backpropagation-through-time technique.

For instance, consider the candidate sequence DEF. The training component 610 iteratively adjusts the parameter values of its model 602 to promote the case in which input vectors associated with events D and E will produce an output vector associated with event F.

A.5. The Global Control System

FIG. 7 shows one implementation of the global control system 108. The global control system 108 includes an interface component 702 for interacting with a plurality of local control systems 704, including the representative local control system 106 of FIG. 1. As described in connection with FIG. 1, the global control system 108 includes a global management system 138 for performing its core functions.

For instance, the global management system 138 includes a registration assistance component 706 for interacting with each local device registration component (such as device registration component 118 of FIG. 1) upon the introduction to a new device in a local control environment. For example, the registration assistance component 706 can retrieve device interface information from the global device information data store 140 and send it to the local device registration component 118, upon request by the local device registration component 118. In addition, the registration assistance component 706 can retrieve a set of default rules form the global rules data store 142 and send it to the local device registration component 118, upon request by the local device registration component 118. In performing the latter function, the registration assistance component 706 can perform a search for a specific device ID associated with a new device under consideration. If that search fails to provide a set of default rules, the registration assistance component 706 can perform a search based on the category ID(s) associated with the new device. Alternatively, the registration assistance component 706 can perform a search in a hierarchical index to generate a set of default rules that is most specific to the new device that is being added to a local control environment 110.

In general, in some cases, the registration assistance component 706 finds a set of default rules that is specifically tailored to the new device under consideration, e.g., corresponding to the same manufacturer and model number of the new device. In other cases, the registration assistance component 706 finds a set of rules that are pertinent to the same family of devices to which the new device belongs.

The global management system 138 also includes an updating component 708 for updating the global rules data store 142 based on rules identified by the local control systems. That is, each local control system may send information to the updating component 708 regarding a rule that a user has approved or rejected. In response, the updating component 708 updates a list of known approved rules and a list of known rejected rules.

The global management system 138 also includes one or more optional global analysis components 710 (including a representative global analysis component 712). Each global analysis component may perform one or more functions. According to a first function, a global analysis component performs analysis to determine whether a candidate rule identified by a local control system is viable from the perspective of the global control system 108. According to a second function, a global analysis component can also determine whether it is appropriate to label a candidate rule as a default rule for a particular kind of device. When so labeled, the registration assistance device 706 downloads this rule (along with other rules) when that kind of device is newly introduced to a local control environment.

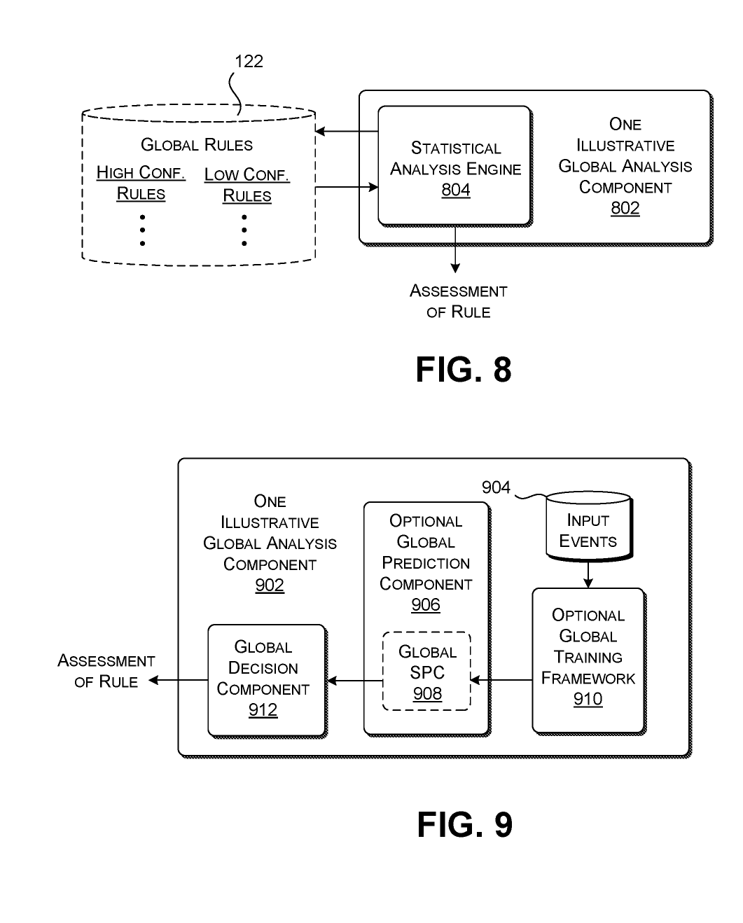

FIG. 8 shows one implementation of one type of global analysis component 802. The global analysis component 802 can include a statistical analysis engine 804 that assesses the viability of a candidate rule by performing statistical analysis on rules approved and rejected by the local control systems 704. For example, the statistical analysis engine 804 can compute a ratio (X/Y) of a number (X) of local control environments which have accepted a candidate rule to a total number (Y) of local control environments that have considered this rule. The statistical analysis engine 804 can then mark the rule as corresponding to a high confidence rule if the ratio exceeds a prescribed threshold value. It can mark the rule as corresponding to a low confidence rule if the ratio is below another prescribed threshold value. (The statistical analysis engine 804 can also include certainty scores that depend on the sample size that is used to generate the above-described ratios.)

The global analysis component 802 can be used in different use case contexts. In one use case, a local control system can use the global analysis component 802 to determine whether a candidate rule generated by a local control environment has a high confidence score or a low confidence score. The local control system can use this information, in turn, to determine whether to accept or reject the candidate rule. In another use case, the registration assistance component 706 can use the global analysis component 712 to determine whether a rule has a high confidence score, indicating that it is appropriate to include this rule in a set of default rules for a device under consideration.

The statistical analysis engine 804 can determine the viability of a rule based on other statistical measures besides (or in addition to) the above-described ratio-based analysis. For instance, the statistical analysis engine 804 can use cluster analysis to perform this task.

FIG. 9 shows another kind of global analysis component 902. In this case, the global analysis component 902 includes a collection of rule-generating components that mirror the same-named components provided by each local control system (and as shown in the representative example of FIG. 1). But the components of FIG. 9 provide their analysis on a global scale, not local. For instance, the global analysis component 902 can include a global events data store 904 for storing signals identified by plural local control systems 704. The signals describe sequences of events identified by the local control systems 704. The global analysis component 902 can also include a global prediction component 906 that generates a prediction based on an input sequence of events. The global prediction component 906 performs this task based on a global sequence prediction component (SPC) 908. A global training framework 910 uses the sequences specified in the global events data store 904 to generate and update a model associated with the global SPC 908 (optionally together with feedback information provided by the local control systems 704). And finally, a global decision component 912 determines the viability of any candidate rule generated by the global prediction component 906. These components operate in the same manner as their counterpart components of the local control system 106, as described above.

The global analysis component 902 can be used in the same two ways set forth above with respect to FIG. 8. For instance, in one use case, the global analysis component 902 can test the viability of a candidate rule specified by a local control system. In another use case, the global analysis component 902 can provide a score which indicates whether it is appropriate to mark a candidate rule as a default rule. Note that while the global analysis component 902 of FIG. 9 performs the same work as a local control system, it may generate a different result compared to the local control system. This is because the global analysis component 902 is trained using a corpus of event sequences that is much larger and varied in scope compared to any local control system.

The two versions of the global analysis components (802, 902) shown in FIGS. 8 and 9 are presented in the spirit of illustration, not limitation. Other implementations can adopt other analysis logic to determine the viability of a rule from a global perspective.

B. Illustrative Processes

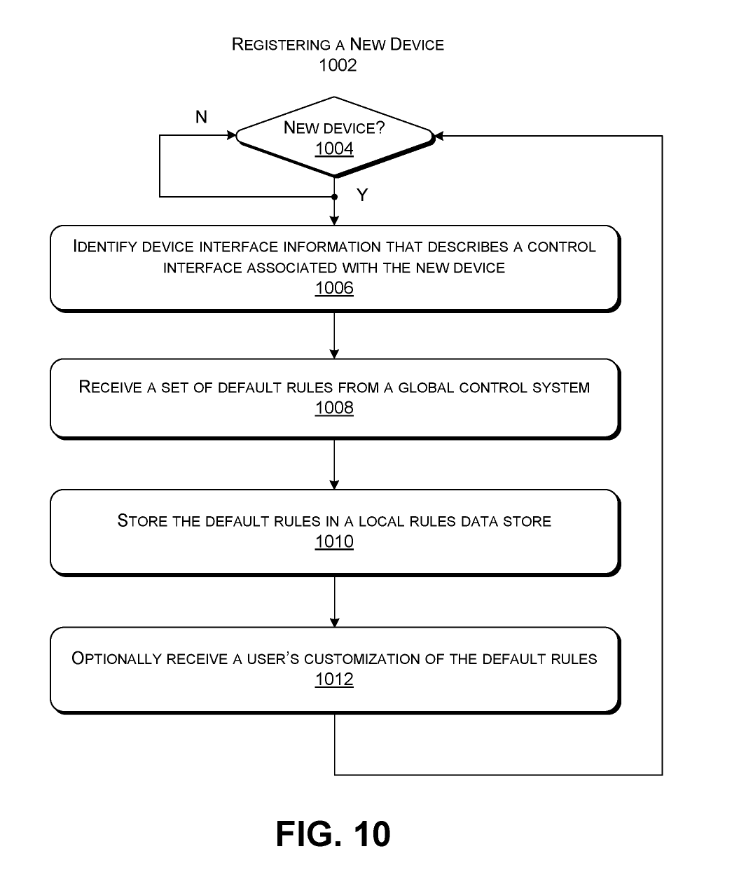

FIGS. 10-13 show a processes that explain the operation of the computing environment 102 of Section A in flowchart form. Since the principles underlying the operation of the computing environment 102 have already been described in Section A, certain operations will be addressed in summary fashion in this section. As noted in the prefatory part of the Detailed Description, each flowchart is expressed as a series of operations performed in a particular order. But the order of these operations is merely representative, and can be varied in any manner.

FIG. 10 shows a process 1002 that explains one way in which the local control system 106 of FIG. 1 handles an introduction of a new device to a collection of devices. In block 1004, the device registration component 118 determines whether a new device has been added to the collection of devices 104. The device registration component 118 performs this task by comparing the device ID (and/or category ID(s)) of the new device to the known IDs of its existing set of devices 104. In block 1006, the device registration component 118 identifies device interface information that describes an electronic interface associated with the new device. In block 1008, the device registration component 118 receives a set of default rules from the global control system 108. In block 1010, the device registration component 118 stores the default rules in the local rules data store 122. In block 1012, the device registration component 118 optionally receives a user's manual customization of any of the default rules.

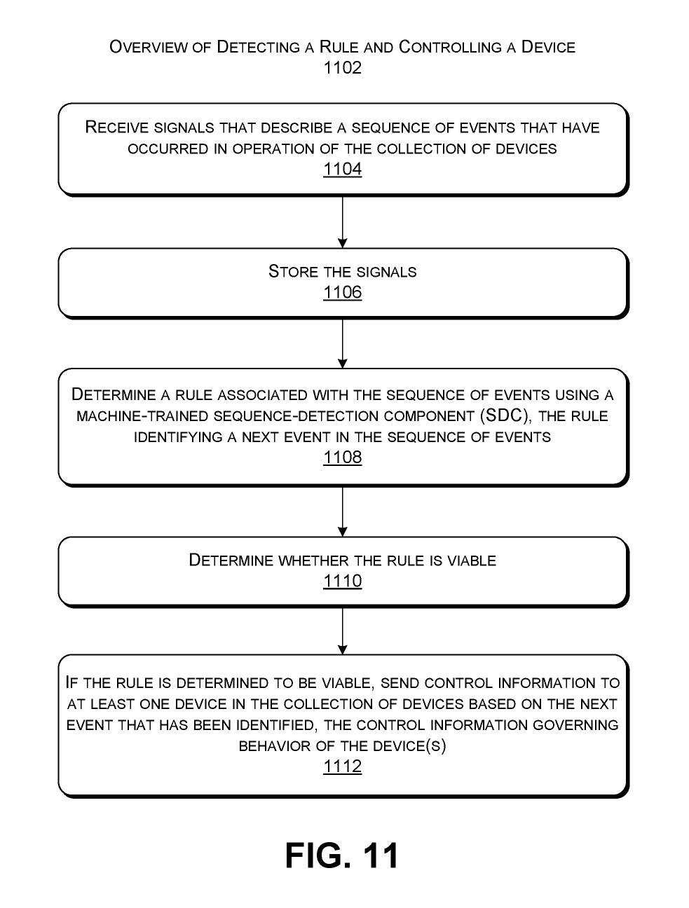

FIG. 11 shows a process 1102 that provides an overview of one manner of operation of the local control system 106 of FIG. 1. In block 1104, the local control system 106 receives signals produced by the collection of devices 104. The signals describe a sequence of events that have occurred in the operation of the collection of devices 104. In block 1106, the local control system 106 stores the signals in an events data store 126. In block 1108, the local control system 106 determines a rule associated with the sequence of events using a machine-trained sequence-detection component (SDC) 130, the rule identifying a next event in the sequence of events. In block 1110, the local control system 106 determines whether the rule is viable. And in block 1112, if the rule is determined to be viable, the local control system 106 sends control information to at least one device in the collection of devices 104 based on the next event that has been identified. The control information governs behavior of the identified device(s), e.g., by carrying out the next action identified by the rule.

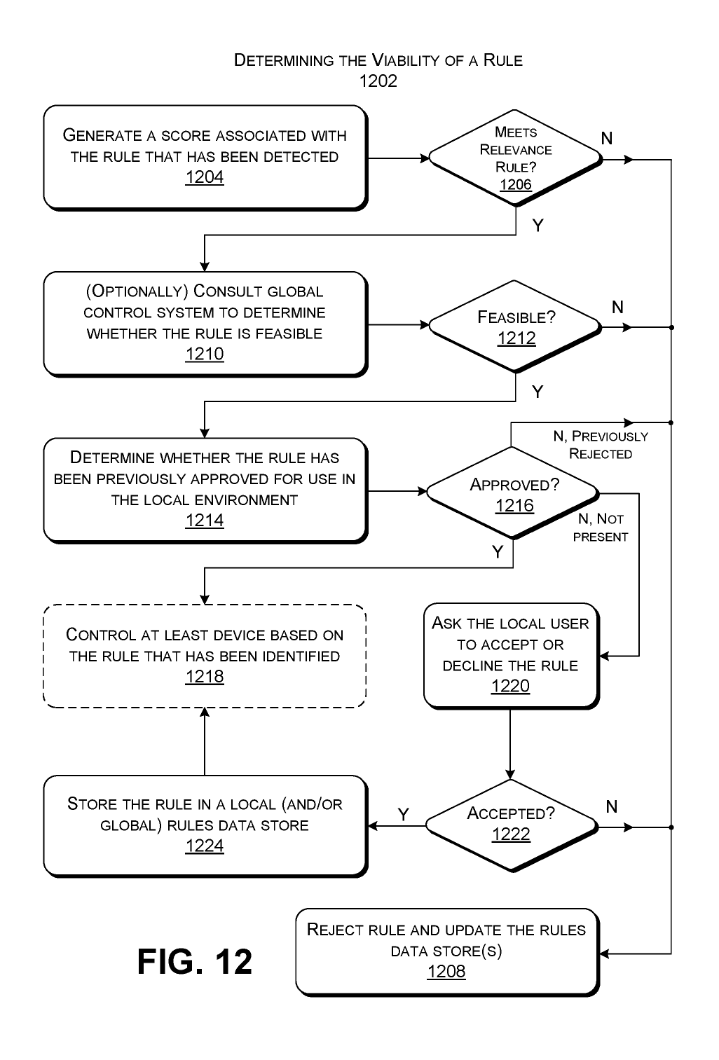

FIG. 12 shows a process 1202 that describes one way of validating a candidate rule in the context of block 1110 of FIG. 11. In block 1204, the local decision component 134 generates a score associated with a candidate rule that has been detected. In block 1206, the local decision component 134 determines whether the score satisfies a prescribed relevance rule. In block 1208, if block 1206 is answered in the negative, then the local decision component 134 rejects the candidate rule; it may also update the rules data store(s) (122, 142) to reflect the fact that the rule has been rejected.

In block 1210, the local decision component 134 (optionally) consults the global control system 108 to determine whether the candidate rule is feasible. In block 1212, the local decision component 134 determines whether a response from the global control system 108 indicates that the candidate rule is feasible. If not, then, in block 1208, the local control system 106 rejects the rule and updates the rules data store(s) (122, 142) to indicate that the rule has been rejected.

In block 1214, the local decision component 134 determines whether the candidate rule has been previously approved for use in the local environment 1214. It performs this task by determining whether the rule is present (and marked as approved) in the local rules data store 122. In block 1216, the local decision component 134 determines whether the result of the inquiry (in block 1214) returns an affirmative result. If so, then, in block 1218, the local control system 106 controls at least one device based on the rule that has been identified. Alternatively assume the result of block 1216 is negative because the candidate rule is present in the local rules data store 122 but is marked as rejected. In this case, the local control system 106 advances to block 1208.

In yet another case, assume that the result of block 1216 is negative because there is no record of the candidate rule in the local rules data store 122. If so, then, in block 1220, the local decision component 134 asks the user whether he or she approves or rejects the proposed rule. In block 1222, the local decision component 134 receives the user's reply. If the user rejects the rule, then the flow again advances to block 1208. In block 1208, the local decision component 134 updates the local rules data store 122, and optionally the global rules data store 142. But if the user accepts the rule, then, in block 1224, the local control system 106 stores the new rule in the local rules data store 122, and optionally the global rules data store 142. It then advances to block 1218, upon which the local control system 106 controls at least one device based on the rule that has been approved.

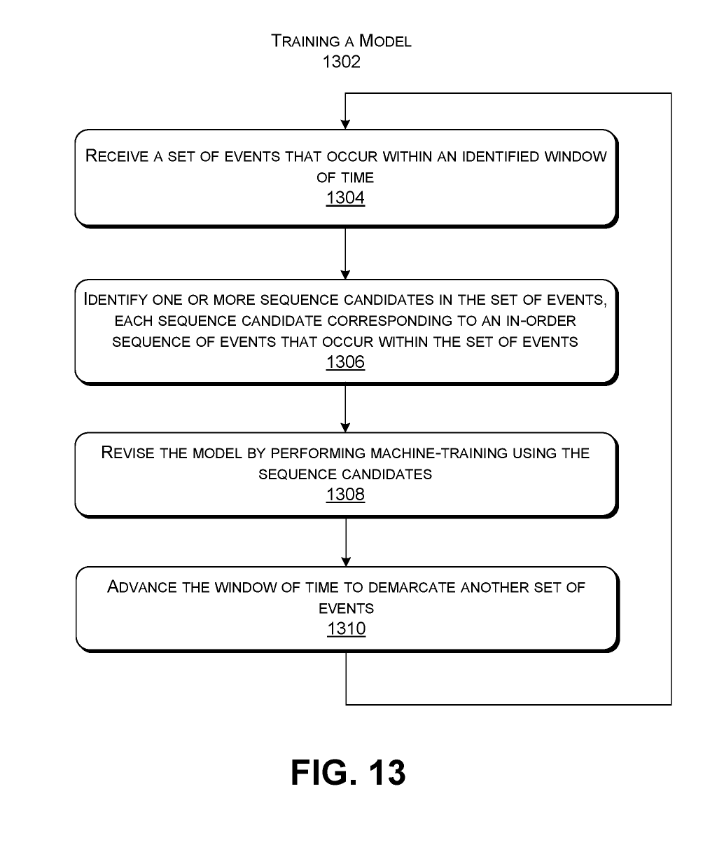

FIG. 13 shows a process 1302 that explains one way of training a model for use in the local control system 106 of FIG. 1. In block 1304, the local training framework 132 receives a set of events that have occurred within an identified window 606 of time. In block 1306, the local training framework 132 identifies one or more candidate sequences in the set of events, each candidate sequence corresponding to an in-order selection of events that occur within the set of events. In block 1308, the local training framework 132 revises the model by performing machine-training using the candidate sequences. And in block 1310, the training framework advances the window 606 of time to demarcate another set of events, upon which the process 1302 is repeated. The global training framework 910 in FIG. 9 (in those implementations in which it is employed) performs the same operations described above.

C. Representative Computing Functionality

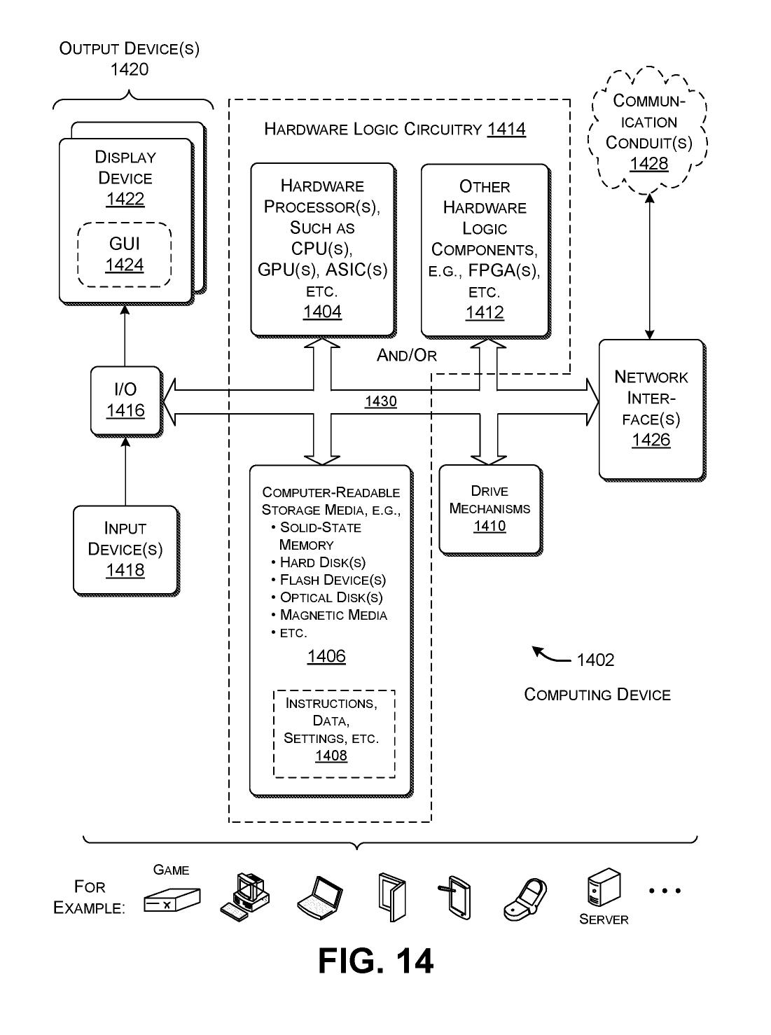

FIG. 14 shows a computing device 1402 that can be used to implement any aspect of the mechanisms set forth in the above-described figures. For instance, the type of computing device 1402 shown in FIG. 14 can be used to implement any server or user computing device in the computing system 202 of FIG. 2. In all cases, the computing device 1402 represents a physical and tangible processing mechanism.

The computing device 1402 can include one or more hardware processors 1404. The hardware processor(s) can include, without limitation, one or more Central Processing Units (CPUs), and/or one or more Graphics Processing Units (GPUs), and/or one or more Application Specific Integrated Circuits (ASICs), etc. More generally, any hardware processor can correspond to a general-purpose processing unit or an application-specific processor unit.

The computing device 1402 can also include computer-readable storage media 1406, corresponding to one or more computer-readable media hardware units. The computer-readable storage media 1406 retains any kind of information 1408, such as machine-readable instructions, settings, data, etc. Without limitation, for instance, the computer-readable storage media 1406 may include one or more solid-state devices, one or more magnetic hard disks, one or more optical disks, magnetic tape, and so on. Any instance of the computer-readable storage media 1406 can use any technology for storing and retrieving information. Further, any instance of the computer-readable storage media 1406 may represent a fixed or removable component of the computing device 1402. Further, any instance of the computer-readable storage media 1406 may provide volatile or non-volatile retention of information.

The computing device 1402 can utilize any instance of the computer-readable storage media 1406 in different ways. For example, any instance of the computer-readable storage media 1406 may represent a hardware memory unit (such as Random Access Memory (RAM)) for storing transient information during execution of a program by the computing device 1402, and/or a hardware storage unit (such as a hard disk) for retaining/archiving information on a more permanent basis. In the latter case, the computing device 1402 also includes one or more drive mechanisms 1410 (such as a hard drive mechanism) for storing and retrieving information from an instance of the computer-readable storage media 1406.

The computing device 1402 may perform any of the functions described above when the hardware processor(s) 1404 carry out computer-readable instructions stored in any instance of the computer-readable storage media 1406. For instance, the computing device 1402 may carry out computer-readable instructions to perform each block of the processes described in Section B.

Alternatively, or in addition, the computing device 1402 may rely on one or more other hardware logic components 1412 to perform operations using a task-specific collection of logic gates. For instance, the other hardware logic component(s) 1412 may include a fixed configuration of hardware logic gates, e.g., that are created and set at the time of manufacture, and thereafter unalterable. Alternatively, or in addition, the other hardware logic component(s) 1412 may include a collection of programmable hardware logic gates that can be set to perform different application-specific tasks. The latter category of devices includes, but is not limited to Programmable Array Logic Devices (PALs), Generic Array Logic Devices (GALs), Complex Programmable Logic Devices (CPLDs), Field-Programmable Gate Arrays (FPGAs), etc.

FIG. 14 generally indicates that hardware logic circuitry 1414 corresponds to any combination of the hardware processor(s) 1404, the computer-readable storage media 1406, and/or the other hardware logic component(s) 1412. That is, the computing device 1402 can employ any combination of the hardware processor(s) 1404 that execute machine-readable instructions provided in the computer-readable storage media 1406, and/or one or more other hardware logic component(s) 1412 that perform operations using a fixed and/or programmable collection of hardware logic gates.

In some cases (e.g., in the case in which the computing device 1402 represents a user computing device), the computing device 1402 also includes an input/output interface 1416 for receiving various inputs (via input devices 1418), and for providing various outputs (via output devices 1420). Illustrative input devices include a keyboard device, a mouse input device, a touchscreen input device, a digitizing pad, one or more static image cameras, one or more video cameras, one or more depth camera systems, one or more microphones, a voice recognition mechanism, any movement detection mechanisms (e.g., accelerometers, gyroscopes, etc.), and so on. One particular output mechanism may include a display device 1422 and an associated graphical user interface presentation (GUI) 1424. The display device 1422 may correspond to a liquid crystal display device, a light-emitting diode display (LED) device, a cathode ray tube device, a projection mechanism, etc. Other output devices include a printer, one or more speakers, a haptic output mechanism, an archival mechanism (for storing output information), and so on. The computing device 1402 can also include one or more network interfaces 1426 for exchanging data with other devices via one or more communication conduits 1428. One or more communication buses 1430 communicatively couple the above-described components together.

The communication conduit(s) 1428 can be implemented in any manner, e.g., by a local area computer network, a wide area computer network (e.g., the Internet), point-to-point connections, etc., or any combination thereof. The communication conduit(s) 1428 can include any combination of hardwired links, wireless links, routers, gateway functionality, name servers, etc., governed by any protocol or combination of protocols.

FIG. 14 shows the computing device 1402 as being composed of a discrete collection of separate units. In some cases, the collection of units may correspond to discrete hardware units provided in a computing device chassis having any form factor. FIG. 14 shows illustrative form factors in its bottom portion. In other cases, the computing device 1402 can include a hardware logic component that integrates the functions of two or more of the units shown in FIG. 1. For instance, the computing device 1402 can include a system on a chip (SoC or SOC), corresponding to an integrated circuit that combines the functions of two or more of the units shown in FIG. 14.

The following summary provides a non-exhaustive set of illustrative aspects of the technology set forth herein.

According to a first aspect, a computer-implemented control system for controlling a collection of devices in a local control environment is described. The control system includes hardware logic circuitry, the hardware logic circuitry corresponding to: (a) one or more hardware processors that perform operations by executing machine-readable instructions stored in a memory, and/or (b) one or more other hardware logic components that perform operations using a task-specific collection of logic gates. The operations include: receiving signals produced by the collection of devices that describe a sequence of events that have occurred in operation of the collection of devices; storing the signals; determining a rule associated with the sequence of events using a machine-trained sequence-detection component (SDC), the rule identifying a next event in the sequence of events; determining whether the rule is viable; and if the rule is determined to be viable, sending control information to at least one device in the collection of devices based on the next event that has been identified, the control information governing behavior of the device(s).

According to a second aspect, the operations further include: determining whether a new device has been added to the collection of devices; and when a new device has been added, identifying device interface information that describes an electronic interface associated with the new device.

According to a third aspect, the operations further include: determining whether a new device has been added to the collection of devices; when a new device has been added, receiving a set of default rules from a global control system; and storing the default rules in a local rules data store. The default rules correspond to rules produced by other local control environments in a course of interacting with a same kind of device as the new device.

According to a fourth aspect, the same kind of device (mentioned in the third aspect) is a device that belongs to a same device family as the new device.

According to a fifth aspect, the machine-trained SDC corresponds to a Recurrent Neural Network (RNN) having a chain of RNN units.

According to a sixth aspect, each RNN unit corresponds to a Long Short-Term Memory (LSTM) unit.

According to a seventh aspect, for at least some of the RNN units, each RNN unit receives an input vector associated with an event that has occurred in the sequence of events, the vector describing a time value associated with the event, a device associated with the event, and an action associated with the event.

According to an eighth aspect, at least one RNN unit receives an input vector that identifies a starting time associated with the sequence of events.

According to a ninth aspect, the determining operation (which determines whether the rule is viable) includes: generating a score associated with the rule that has been detected; determining whether the score satisfies a relevance rule; and rejecting the rule if the score fails to satisfy the relevance rule.

According to a tenth aspect, the determining operation (which determines whether the rule is viable) includes: consulting a global control system to determine whether the rule is feasible, the global control system making a determination of whether the rule is feasible based on feedback provided by plural other local control environments; receiving a response from the global control system as to whether the rule is feasible; and rejecting the rule if the response indicates that the rule is not feasible.

According to an eleventh aspect, the determining operation (which determines whether the rule is viable) includes: determining whether the rule has been previously approved for use in the local environment; requesting a local user to accept or decline the rule if there is no record that the rule has been approved or rejected on a prior occasion; and rejecting the rule if the local user declines the rule.

According to a twelfth aspect, the operations further include sending at least one rule approved by a local user within the local control environment to a global control system for storage thereat.

According to a thirteenth aspect, the control information instructs the device(s) to perform the next event that has been identified.

According to a fourteenth aspect, the operations further include updating a model that governs operation of the machine-trained SDC. The updating includes: receiving a set of events that have occurred within an identified window of time; identifying one or more candidate sequences in the set of events, each candidate sequence corresponding to an in-order selection of events that occur within the set of events; revising the model by performing machine-training using the candidate sequences; and advancing the window of time to demarcate another set of events, and repeated the operations of receiving a set of events, identifying one or more candidate sequences, and revising the model.

According to a fifteenth aspect, a method is described for controlling a collection of devices in a local control environment. The method includes: receiving signals produced by the collection of devices that describe a sequence of events that have occurred in operation of the collection of devices; storing the signals; determining a rule associated with the sequence of events using a machine-trained sequence-detection component (SDC), the SDC having a recurrent chain of units, one of the units in the chain identifying a next event in the sequence of events; determining whether the rule is viable; and if the rule is determined to be viable, sending control information to at least one device in the collection of devices, the control information instructing the device(s) to perform the next event that has been identified.

According to a sixteenth aspect, the method of the fifteenth aspect further includes: determining whether a new device has been added to the collection of devices; when a new device has been added, receiving a set of default rules from a global control system; and storing the default rules in a local rules data store. The default rules correspond to rules produced by other local control environments in a course of interacting with a same kind of device as the new device

According to a seventeenth aspect, the determining operation of the fifteenth aspect (which determines whether the rule is viable) includes: determining whether the rule has been previously approved for use in the local environment; requesting a local user to accept or decline the rule if there is no record that the rule has been approved or rejected on a prior occasion; and rejecting the rule if the local user declines the rule.

According to an eighteenth aspect, the method of the fifteenth aspect further includes updating a model that governs operation of the machine-trained SDC. The updating operation includes: receiving a set of events that have occurred within an identified window of time; identifying one or more candidate sequences in the set of events, each candidate sequence corresponding to an in-order selection of events that occur within the set of events; revising the model by performing machine-training using the candidate sequences; and advancing the window of time to demarcate another set of events, and repeated the operations of receiving a set of events, identifying one or more candidate sequences, and revising the model.

According to a nineteenth aspect, a computer-readable storage medium is described for storing computer-readable instructions, the computer-readable instructions, when executed by one or more hardware processor devices, performing a method. The method includes: receiving signals produced by a collection of devices that describe a sequence of events that have occurred in operation of the collection of devices; storing the signals; determining a rule associated with the sequence of events using a machine-trained sequence-detection component (SDC), the rule identifying a next event in the sequence of events; determining whether the rule is viable; and if the rule is determined to be viable, sending control information to at least one device in the collection of devices based on the next event that has been identified, the control information governing behavior of the device(s).

According to a twentieth aspect (dependent on the nineteenth aspect), the method further includes updating a model that governs operation of the machine-trained SDC. The updating includes: receiving a set of events that have occurred within an identified window of time; identifying one or more candidate sequences in the set of events, each candidate sequence corresponding to an in-order selection of events that occur within the set of events; revising the model by performing machine-training using the candidate sequences; and advancing the window of time to demarcate another set of events, and repeated the operations of receiving a set of events, identifying one or more candidate sequences, and revising the model.

A twenty-first aspect corresponds to any combination (e.g., any permutation or subset that is not logically inconsistent) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented control system for controlling a collection of devices in a local control environment, comprising:
hardware logic circuitry, the hardware logic circuitry corresponding to: (a) one or more hardware processors that perform operations by executing machine-readable instructions stored in a memory, and/or (b) one or more other hardware logic components that perform operations using a task-specific collection of logic gates, the operations including:
receiving signals produced by the collection of devices that describe a sequence of events that have occurred in operation of the collection of devices;
storing the signals;
determining a rule associated with the sequence of events using a machine-trained sequence-detection component (SDC), the rule identifying a next event in the sequence of events;
determining whether the rule is viable; and
if the rule is determined to be viable, sending control information to at least one device in the collection of devices based on the next event that has been identified,
the control information governing behavior of said at least one device.

2. The computer-implemented control system of claim 1, wherein the operations further include:
determining whether a new device has been added to the collection of devices; and
when a new device has been added, identifying device interface information that describes an electronic interface associated with the new device.

3. The computer-implemented control system of claim 1, wherein the operations further include:
determining whether a new device has been added to the collection of devices;
when a new device has been added, receiving a set of default rules from a global control system; and
storing the default rules in a local rules data store,
the default rules corresponding to rules produced by other local control environments in a course of interacting with a same kind of device as the new device.

4. The computer-implemented control system of claim 3, wherein the same kind of device is a device that belongs to a same device family as the new device.

5. The computer-implemented control system of claim 1, wherein the machine-trained SDC corresponds to a Recurrent Neural Network (RNN) having a chain of RNN units.

6. The computer-implemented control system of claim 5, wherein each RNN unit corresponds to a Long Short-Term Memory (LSTM) unit.

7. The computer-implemented control system of claim 5, wherein, for at least some of the RNN units, each RNN unit receives an input vector associated with an event that has occurred in the sequence of events, the vector describing a time value associated with the event, a device associated with the event, and an action associated with the event.

8. The computer-implemented control system of claim 5, wherein at least one RNN unit receives an input vector that identifies a starting time associated with the sequence of events.

9. The computer-implemented control system of claim 1, wherein said determining whether the rule is viable includes:
generating a score associated with the rule that has been detected;
determining whether the score satisfies a relevance rule; and
rejecting the rule if the score fails to satisfy the relevance rule.

10. The computer-implemented control system of claim 1, wherein said determining whether the rule is viable includes:
consulting a global control system to determine whether the rule is feasible, the global control system making a determination of whether the rule is feasible based on feedback provided by plural other local control environments;
receiving a response from the global control system as to whether the rule is feasible; and
rejecting the rule if the response indicates that the rule is not feasible.

11. The computer-implemented control system of claim 1, wherein said determining whether the rule is viable includes:
determining whether the rule has been previously approved for use in the local environment;
requesting a local user to accept or decline the rule if there is no record that the rule has been approved or rejected on a prior occasion; and
rejecting the rule if the local user declines the rule.

12. The computer-implemented control system of claim 1, wherein the operations further include sending at least one rule approved by a local user within the local control environment to a global control system for storage thereat.

13. The computer-implemented control system of claim 1, wherein the control information instructs said at least one device to perform the next event that has been identified.

14. The computer-implemented control system of claim 1, wherein the operations further include updating a model that governs operation of the machine-trained SDC, said updating comprising:
receiving a set of events that have occurred within an identified window of time;
identifying one or more candidate sequences in the set of events, each candidate sequence corresponding to an in-order selection of events that occur within the set of events;
revising the model by performing machine-training using the candidate sequences; and
advancing the window of time to demarcate another set of events, and repeated said receiving a set of events, said identifying one or more candidate sequences, and said revising the model.

15. A method for controlling a collection of devices in a local control environment, comprising:
receiving signals produced by the collection of devices that describe a sequence of events that have occurred in operation of the collection of devices;
storing the signals;
determining a rule associated with the sequence of events using a machine-trained sequence-detection component (SDC), the SDC having a recurrent chain of units, one of the units in the chain identifying a next event in the sequence of events;
determining whether the rule is viable; and
if the rule is determined to be viable, sending control information to at least one device in the collection of devices, the control information instructing said at least one device to perform the next event that has been identified.

16. The method of claim 15, wherein the method further comprises:
determining whether a new device has been added to the collection of devices;
when a new device has been added, receiving a set of default rules from a global control system; and
storing the default rules in a local rules data store,
the default rules corresponding to rules produced by other local control environments in a course of interacting with a same kind of device as the new device

17. The method of claim 15, wherein said determining whether the rule is viable includes:
determining whether the rule has been previously approved for use in the local environment;
requesting a local user to accept or decline the rule if there is no record that the rule has been approved or rejected on a prior occasion; and
rejecting the rule if the local user declines the rule.

18. The method of claim 15, wherein the method further includes updating a model that governs operation of the machine-trained SDC, said updating comprising:
receiving a set of events that have occurred within an identified window of time;
identifying one or more candidate sequences in the set of events, each candidate sequence corresponding to an in-order selection of events that occur within the set of events;
revising the model by performing machine-training using the candidate sequences; and
advancing the window of time to demarcate another set of events, and repeated said receiving a set of events, said identifying one or more candidate sequences, and said revising the model.

19. A computer-readable storage medium for storing computer-readable instructions, the computer-readable instructions, when executed by one or more hardware processor devices, performing a method that comprises:
receiving signals produced by a collection of devices that describe a sequence of events that have occurred in operation of the collection of devices;
storing the signals;
determining a rule associated with the sequence of events using a machine-trained sequence-detection component (SDC), the rule identifying a next event in the sequence of events;
determining whether the rule is viable; and
if the rule is determined to be viable, sending control information to at least one device in the collection of devices based on the next event that has been identified,
the control information governing behavior of said at least one device.

20. The computer-readable storage medium of claim 19, wherein the method further includes updating a model that governs operation of the machine-trained SDC, said updating comprising:
receiving a set of events that have occurred within an identified window of time;
identifying one or more candidate sequences in the set of events, each candidate sequence corresponding to an in-order selection of events that occur within the set of events;
revising the model by performing machine-training using the candidate sequences; and
advancing the window of time to demarcate another set of events, and repeated said receiving a set of events, said identifying one or more candidate sequences, and said revising the model.
